(19) United States
(12) Patent Application Publication
(10) Pub. No.: US 2024/0388114 A1
(43) Pub. Date: Nov. 21, 2024

(54) CONSTANT CURRENT CHARGING DEVICE

(71) Applicant: SILICON INTEGRATED SYSTEMS CORP., Hsinchu City (TW)

(72) Inventors: Song Sheng LIN, Hsinchu City (TW); Keng-Nan CHEN, Hsinchu City (TW)

(73) Assignee: SILICON INTEGRATED SYSTEMS CORP., Hsinchu City (TW)

(21) Appl. No.: 18/665,138

(22) Filed: May 15, 2024

(30) Foreign Application Priority Data
May 18, 2023 (TW) 112118594

(51) Int. Cl. H02J 7/00; G05F 3/16

(52) U.S. Cl. CPC H02J 7/00712; G05F 3/16

(57) ABSTRACT

A constant current charging device is configured to charge a device to be charged and includes: a reference current source; a current mirror electrically coupled to the reference current source and configured to output a mirror current; a current adjustment control unit electrically coupled to the current mirror and the device to be charged; and a current compensation unit electrically coupled to the current mirror and the current adjustment control unit. The current adjustment control unit includes a control transistor and a control contact connected to an output terminal of the current compensation unit and the control transistor, wherein the current adjustment control unit controls the control transistor according to a charging voltage to reduce current flows through the control contact.

### CROSS-REFERENCE TO RELATED APPLICATIONS

This application claims benefit of priority to Taiwan Patent Application No. 112118594 filed on May 18, 2023 in the Taiwan Intellectual Property Office, the disclosure of which is incorporated herein by reference in its entirety.

### FIELD OF INVENTION

The present invention relates to the field of charging technology, and in particular to a constant current charging device.

### BACKGROUND OF INVENTION

Conventional charging devices include two charging modes: a constant current charging mode and a constant voltage charging mode. The charging device charges the battery in the constant current charging mode when the battery starts charging. The charging device switches to the constant voltage charging mode to charge the battery after the battery is charged to a certain voltage.

However, maintaining a stable output of current and voltage provided by conventional charging devices is challenging. Unstable current and voltage output can result in reduced charging efficiency and shorten the battery service life.

Therefore, it is necessary to propose a solution to the problems of the above-mentioned conventional technology.

### SUMMARY OF INVENTION

The purpose of the present invention is to properly solve the above-mentioned problems of the prior art without significantly increasing the design complexity or production cost.

Based on the above objectives, the present invention provides a constant current charging device configured to charge a device to be charged, the constant current charging device includes: a reference current source providing a reference current; a current mirror electrically coupled to the reference current source and outputting a mirror current; a current adjustment control unit electrically coupled to the current mirror and the device to be charged, wherein the current adjustment control unit outputs a charging current according to the mirror current to charge the device to be charged; and a current compensation unit electrically coupled to the current mirror and the current adjustment control unit, wherein the current adjustment control unit includes a control transistor and a control contact connected to an output terminal of the current compensation unit and the control transistor, and wherein the current adjustment control unit adjusts the control transistor according to a charging voltage to reduce a current flowing through the control contact.

The present invention has the following beneficial effects: one can design the charging current of the constant current charging device of the present invention according to the channel width-to-length ratio of the transistors of the current mirror and the channel width-to-length ratio of the transistors of the current adjustment control unit. Furthermore, the constant current charging device of the present invention can provide stable charging current and charging voltage through the current adjustment control unit and the current compensation unit. Finally, the constant current charging device of the present invention can shorten the conversion time between constant current charging and constant voltage charging by adjusting the voltage and the current flowing through the control contact.

The purpose, technical content, characteristics, and effects achieved by the present invention will be more easily understood through detailed descriptions of specific embodiments and accompanying figures.

### DESCRIPTION OF FIGURES

FIG. 1 shows a block diagram of a constant current charging device according to one embodiment of the present invention.

FIG. 2 shows a detailed circuit diagram of the constant current charging device of FIG. 1 of the present invention.

FIG. 3 shows a simulation diagram of a charging current I_{C} and a charging voltage V_{C} in FIG. 2 of the present invention.

FIG. 4 shows a voltage simulation diagram of a first contact p1 to a fourth contact p4 in FIG. 2 of the present invention.

### DETAILED DESCRIPTION OF EMBODIMENTS

The present disclosure is particularly described with the following examples. These examples are only used for illustration. For those skilled in the art, various modifications can be made without departing from the spirit and scope of the present invention. Therefore, the scope of protection of the present invention shall be determined by the appended claims. Referring to the drawings in the figures, the same reference numerals represent the same elements.

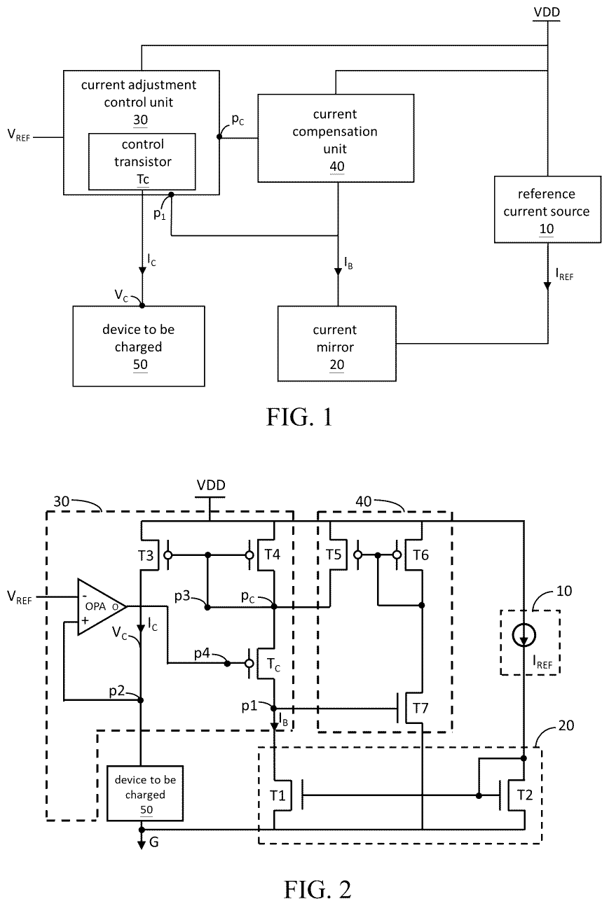

Please refer to FIG. 1 and FIG. 2, FIG. 1 shows a block diagram of a constant current charging device according to one embodiment of the present invention. FIG. 2 shows a detailed circuit diagram of the constant current charging device of FIG. 1 of the present invention.

The constant current charging device of the present invention is configured to charge a device to be charged 50 and includes a reference current source 10, a current mirror 20, a current adjustment control unit 30, and a current compensation unit 40.

The device to be charged 50 is a circuit or a rechargeable battery that needs to be charged, or an electronic device including the aforementioned circuit or the rechargeable battery that needs to be charged.

The reference current source 10 is electrically coupled to the power supply VDD and provides the reference current I_{REF}. The power supply VDD can be a DC power supply. The reference current I_{REF} can be adjusted according to needs.

The current mirror 20 is electrically coupled to the reference current source 10 and outputs a mirror current I_{B}, wherein the mirror current I_{B} can be M times the reference current I_{REF}.

The current adjustment control unit 30 is electrically coupled to the power supply VDD, the current mirror 20, and the device to be charged 50. The current adjustment control unit 30 outputs the charging current I_{C} according to the mirror current I_{B} to charge the device to be charged 50, wherein the charging current I_{C} may be N times the mirror current I_{B}. That is, the constant current charging device of the present invention outputs the charging current I_{C} through the current mirror 20 and the current adjustment control unit 30, and the output charging current I_{C} is M×N times the reference current I_{REF}. M, N, and M×N are all positive numbers. It should be noted that the current adjustment control unit 30 further includes a control transistor T_{C}. A control contact p_{C} of the current adjustment control unit 30 is connected to an output terminal of the current compensation unit 40 and the control transistor T_{C}. The current adjustment control unit 30 adjusts the control transistor T_{C} according to the charging voltage V_{C} to reduce the current flowing through the control contact T_{C}.

The current compensation unit 40 is electrically coupled to the power supply VDD, the current mirror 20, and the current adjustment control unit 30. The current compensation unit 40 compensates the charging current I_{C} according to the reference voltage V_{REF}. In more detail, the constant current charging device of the present invention can be controlled by the current compensation unit 40 to increase or decrease the charging current I_{C}. Furthermore, the current compensation unit 40 can be designed to influence a voltage of the control contact p_{C}. The reference voltage V_{REF} used to control the current compensation unit 40 can be adjusted according to needs.

It should be noted that, as shown in FIG. 1, the control contact p_{C} electrically coupled between the current adjustment control unit 30 and the current compensation unit 40 is different from a contact electrically coupled between the current adjustment control unit 30, the current mirror 20, and the current compensation unit 40. The constant current charging device in FIG. 1 of the present invention will be elaborated upon further in FIG. 2.

Referring to FIG. 2, the current mirror 20 includes a first transistor T1 and a second transistor T2. The first transistor T1 includes a first control terminal, a first input terminal, and a first output terminal. The second transistor T2 includes a second control terminal, a second input terminal, and a second output terminal.

The first control terminal is electrically coupled to the reference current source 10 and the second control terminal. The first input terminal is electrically coupled to the control transistor T_{C} and the current compensation unit 40. The first output terminal is electrically coupled to a ground terminal G. The second input terminal is electrically coupled to the reference current source 10. The second output terminal is electrically coupled to the ground terminal G.

In this embodiment, the first transistor T1 and the second transistor T2 can be N-type metal-oxide-semiconductor field-effect transistors (N-MOSFET).

The current adjustment control unit 30 includes an operational amplifier OPA, a third transistor T3, a fourth transistor T4, and the control transistor T_{C}. The operational amplifier OPA includes an inverting input terminal −, a non-inverting input terminal +, and an output terminal O. The third transistor T3 includes a third control terminal, a third input terminal, and a third output terminal. The fourth transistor T4 includes a fourth control terminal, a fourth input terminal, and a fourth output terminal. The control transistor T_{C} includes a control terminal, a control input terminal, and a control output terminal.

The inverting input terminal − of the operational amplifier OPA is electrically coupled to the reference voltage V_{REF}, and the non-inverting input terminal + of the operational amplifier OPA is electrically coupled to the device to be charged 50 and the third output terminal. The output terminal O is electrically coupled to the control terminal of the control transistor T_{C}. The third control terminal is electrically coupled to the fourth control terminal and the control contact p_{C}. The third input terminal is electrically coupled to the power supply VDD. The fourth input terminal is electrically coupled to the power supply VDD. The fourth output terminal is electrically coupled to the input terminal of the control transistor T_{C}. The output terminal of the control transistor T_{C} is electrically coupled to the first input terminal.

It should be noted that the present invention can adjust the correlation parameters between the reference voltage V_{REF} and the reference current I_{REF} of the constant current charging device by designing internal resistances and external resistances of the operational amplifier OPA and the device to be charged 50, or by additionally increasing the resistance between lines. For example, a designer can add a resistor between the non-inverting input terminal + of the operational amplifier OPA and the second contact p2, or add a resistor between the second contact p2 and the device to be charged 50, or add a resistor between the second contact p2 and the third output terminal to design a ratio between the charging voltage V_{C} and the reference voltage V_{REF}, and to make a maximum value of the charging voltage V_{C} not limited by a maximum value of the reference voltage V_{REF}.

In this embodiment, the third transistor T3 and the fourth transistor T4 may be P-type metal-oxide-semiconductor field-effect transistors (P-MOSFET).

The current compensation unit 40 includes a fifth transistor T5, a sixth transistor T6, and a seventh transistor T7. The fifth transistor T5 includes a fifth control terminal, a fifth input terminal, and a fifth output terminal. The sixth transistor T6 includes a sixth control terminal, a sixth input terminal, and a sixth output terminal. The seventh transistor T7 includes a seventh control terminal, a seventh input terminal, and a seventh output terminal.

The fifth control terminal is electrically coupled to the sixth control terminal, the sixth output terminal, and the seventh input terminal. The fifth input terminal is electrically coupled to the power supply VDD. The fifth output terminal is electrically coupled to the control contact p_{C}. The sixth input terminal is electrically coupled to the power supply VDD. The seventh control terminal is coupled to the control output terminal. The seventh output terminal is electrically coupled to the ground terminal G.

In this embodiment, the fifth transistor T5 and the sixth transistor T6 can be P-MOSFETs. The seventh transistor T7 can be an N-MOSFET.

The operating principle of the constant current charging device of the present invention will be described in detail below.

First, the charging voltage V_{C} is zero in an initial state, the voltage of the non-inverting input terminal + of the operational amplifier OPA (that is, equal to zero) is less than the reference voltage V_{REF}, and the output terminal O of the operational amplifier OPA outputs a low voltage level. The control transistor T_{C} is turned on, so that the third transistor T3, the fourth transistor T4, and the seventh transistor are turned on. The fifth transistor T5 and the sixth transistor T6 are turned on when the seventh transistor T7 is turned on. When the current flows through the fifth transistor T5, it will affect the voltage of the control contact p_{C} and the voltage of the third contact p3, thereby affecting the current flowing through the fourth transistor and the charging current I_{C}.

In more detail, the mirror current I_{B} is related to a channel width-to-length ratio (W1/L1) of the first transistor T1 and a channel width-to-length ratio (W2/L2) of the second transistor T2. M is a ratio of the channel width-to-length ratio (W1/L1) of the first transistor T1 and the channel width-to-length ratio (W2/L2) of the second transistor T2. W1 is a channel width of the first transistor T1. L1 is a channel length of the first transistor T1. W2 is a channel width of the second transistor T2. L2 is a channel length of the second transistor T2. A relationship between the mirror current I_{B} and the reference current I_{REF} is as follows:

$${I}_{B} = M \times {I}_{REF} = ( \frac{W 1}{L 1} / \frac{W 2}{L 2} ) \times {I}_{REF}$$

The charging current I_{C} is related to a channel width-to-length ratio (W3/L3) of the third transistor T3 and a channel width-to-length ratio of the fourth transistor T4 (W4/L4). N is a ratio of the channel width-to-length ratio (W3/L3) of the third transistor T3 and the channel width-to-length ratio (W4/L4) of the fourth transistor T4. W3 is a channel width of the third transistor T3. L3 is a channel length of the third transistor T3. W4 is a channel width of the fourth transistor T4. L4 is a channel length of the fourth transistor T4. A relationship between the charging current I_{C} and the mirror current I_{B} is as follows:

$${I}_{C} = N \times {I}_{B} = N \times M \times {I}_{REF} = ( \frac{W 3}{L 3} / \frac{W 4}{L 4} ) \times ( \frac{W 1}{L 1} / \frac{W 2}{L 2} ) \times {I}_{REF}$$

From the above, it can be seen that the constant current charging device of the present invention can provide a stable charging current I_{C} by designing the channel width-to-length ratio (W1/L1) of the first transistor T1, the channel width-to-length ratio (W2/L2) of the second transistor T2, the channel width-to-length ratio (W3/L3) of the third transistor T3, and the channel width-to-length ratio (W4/L4) of the fourth transistor T4. Therefore, the charging current I_{C} is controllable and can be designed to have a high current value.

The output terminal O of the operational amplifier OPA outputs a high voltage level when the charging voltage V_{C} rises and the voltage at the non-inverting input terminal + of the operational amplifier OPA approaches the reference voltage V_{REF}. This causes the current flowing through the control transistor T_{C} to decrease, which in turn reduces the current flowing through the third transistor T3 and the fourth transistor T4. The charging current I_{C} also decreases as the current flowing through the fourth transistor T4 decreases.

The special aspect to note is that the constant current charging circuit provided by the present invention connects the output terminal O of the operational amplifier OPA to the control terminal of the control transistor T_{C}, and the input terminal of the control transistor T_{C}, the fourth output terminal, and the fifth output terminal are electrically coupled. Therefore, the control transistor T_{C} reduces the current flowing through the control contact p_{C} before the mirror current I_{B} is amplified by the current adjustment control unit 30 when the output terminal O of the operational amplifier OPA gradually outputs a high potential, thereby significantly reducing the transition time between constant current charging and constant voltage charging of the constant current charging device of the present invention. At the same time, the control contact p_{C} which is electrically coupled to the input terminal of the control transistor T_{C} is also electrically coupled to the fourth output terminal, the fifth output terminal, the third control terminal, and the fourth control terminal, wherein the third control terminal and the fourth control terminal are not directly electrically coupled to the output terminal O of the operational amplifier OPA, therefore, the charging current I_{C} can still maintain a stable output even if the control transistor T_{C} is gradually turned off during the charging voltage V_{C} rises. Therefore, the control transistor T_{C} and the control contact p_{C} have the effect of greatly reducing the rising time of the charging voltage V_{C} and the falling time of the charging current I_{C} of the constant current charging circuit of the present invention, while stabilizing the charging current I_{C} and the charging voltage V_{C}.

The current adjustment control unit 30 reduces the charging current I_{C} when the charging voltage V_{C} rises and the receiving voltage of the non-inverting input terminal + approaches the reference voltage V_{REF}. The charging current I_{C} is zero when the voltage at the non-inverting input terminal + is equal to the reference voltage V_{REF}.

In summary, the constant current charging device of the present invention can provide stable charging current I_{C} and charging voltage V_{C} through the current adjustment control unit 30 and the current compensation unit 40. Furthermore, the constant current charging device of the present invention can provide a controllable charging current I_{C} with a high current value through the current mirror 20 and the current adjustment control unit 30. In addition, the constant current charging device of the present invention can extend the duration of the current output of the charging current I_{C} and significantly reduce the time to decrease the charging current I_{C} and to increase the charging voltage V_{C} by controlling the voltage and the current flowing through the control point p_{C}.

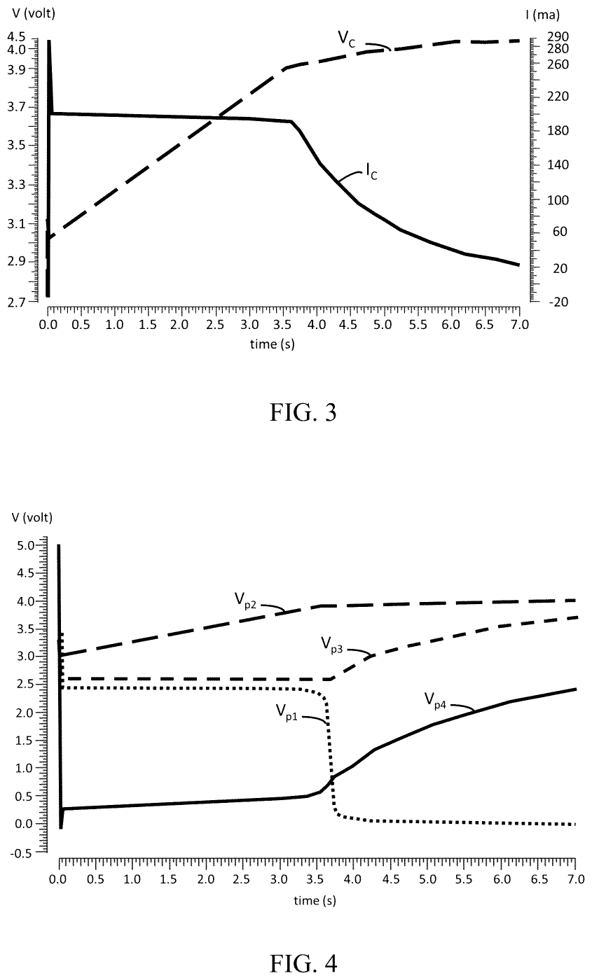

Please refer to FIG. 3, which shows a simulation diagram of the charging current I_{C} and the charging voltage V_{C} in FIG. 2.

In the simulation diagram of FIG. 3, under one of the implementation conditions: the power supply VDD is 5 volts, the reference voltage V_{REF} is 1.2 volts, the reference current I_{REF} is 100 microamps, the charging current is 200 milliamperes, and the device to be charged 50 has 1-farad capacitance.

As can be seen from FIG. 3, the charging current I_{C} can quickly provide a stable current (200 mA). Even if the charging voltage V_{C} gradually rises, the charging current I_{C} can still maintain a current output of about 200 mA. The charging current I_{C} drops sharply to 20 milliamps when the charging voltage V_{C} rises to about 3.92 volts. It only takes about 7 seconds for the charging voltage to rise from 0 to 4.0 volts and the charging current to drop from 200 mA to 20 mA.

That is, by combining the current mirror 20, the current compensation unit 40, and the control transistor T_{C} with the current adjustment control unit 30, the constant current charging circuit disclosed in FIG. 2 of the present invention provides a charging current I_{C} with a smoother high-current output and faster-falling efficiency and provides a charging voltage V_{C} with a smoother high-voltage output and faster-rising efficiency.

Please refer to FIG. 4, FIG. 4 shows a voltage simulation diagram of the first contact p1 to the fourth contact p4 in FIG. 2 of the present invention.

As can be seen from FIG. 4, the voltages of the second contact p2, the third contact p3, and the fourth contact p4 rise synchronously, and even if the rising curve of the second contact p2 begins to be gentle, the voltages of the third contact p3 and the fourth contact p4 still keeps rising for a certain period. At about 3.6 seconds, the voltage of the first contact p1 drops sharply to close to zero. At the same time, at about 3.6 seconds, the voltage Vₚ₂ of the second contact p2 can be stably output close to the maximum voltage (4.0 volts). In addition, overall, the voltage of the second contact p2, the third contact p3 and the fourth contact p4 rises in only 7 seconds.

The constant current charging device of the present invention can provide stable and controllable charging current through the current adjustment control unit and the current compensation unit (as shown in FIG. 3). Furthermore, the charging current of the constant current charging device of the present invention can be designed according to the channel width-to-length ratio of the transistors of the current mirror and the channel width-to-length ratio of the transistors of the current adjustment control unit. Finally, the constant current charging device of the present invention can provide stable charging current and stable charging voltage through the current adjustment control unit and the current compensation unit (as shown in FIG. 3 and FIG. 4), thereby improving charging efficiency and service life of the connected device to be charged.

It should be noted that the combination of various elements in the present invention preferably forms the above-mentioned multiple embodiments, but this should not be interpreted as a limitation of the present invention. That is, there can be more combinations of various elements in the present invention and is not limited to the above-mentioned embodiments.

This specification uses specific examples to illustrate the principles and implementation methods of the present invention. The description of the above embodiments is only used to help understand the technical solutions and core ideas of the present invention. Those of ordinary skill in the art should understand that they can still modify the technical solutions recorded in the foregoing embodiments, or make equivalent substitutions for some of the technical features. However, these modifications or substitutions do not cause the essence of the corresponding technical solution to depart from the scope of the technical solution of each embodiment of the present invention.

What is claimed is:

1. A constant current charging device configured to charge a device to be charged, the constant current charging device comprises:
a reference current source providing a reference current;
a current mirror electrically coupled to the reference current source and outputting a mirror current;
a current adjustment control unit electrically coupled to the current mirror and the device to be charged, the current adjustment control unit outputs a charging current according to the mirror current to charge the device to be charged; and
a current compensation unit electrically coupled to the current mirror and the current adjustment control unit,
wherein the current adjustment control unit comprises a control transistor and a control contact connected to an output terminal of the current compensation unit and the control transistor, and wherein the current adjustment control unit adjusts the control transistor according to a charging voltage to reduce a current flowing through the control contact.

2. The constant current charging device according to claim 1, wherein the mirror current is M times the reference current, and M is a positive number, and wherein the charging current is N times the mirror current, and N is a positive number.

3. The constant current charging device according to claim 1, wherein the current adjustment control unit comprises a first contact electrically coupled to the current compensation unit and the current mirror, and wherein the current adjustment control unit receives the mirror current through the first contact.

4. The constant current charging device according to claim 2, wherein the current mirror comprises:
a first transistor comprising a first control terminal, a first input terminal, and a first output terminal; and
a second transistor comprising a second control terminal, a second input terminal, and a second output terminal,
wherein the first control terminal is electrically coupled to the reference current source and the second control terminal, wherein the first input terminal is electrically coupled to the control transistor and the current compensation unit, wherein the first output terminal is electrically coupled to a ground terminal, wherein second input terminal is electrically connected to the reference current source, and wherein the second output terminal is electrically coupled to the ground terminal.

5. The constant current charging device according to claim 4, wherein the current adjustment control unit comprises:
an operational amplifier comprising an inverting input terminal, a non-inverting input terminal, and an output terminal;
a third transistor comprising a third control terminal, a third input terminal, and a third output terminal;
a fourth transistor comprising a fourth control terminal, a fourth input terminal, and a fourth output terminal; and
the control transistor comprising a control terminal, an input terminal, and an output terminal,
wherein the inverting input terminal is electrically coupled to a reference voltage, wherein the non-inverting input terminal is electrically coupled to the device to be charged and the third output terminal, wherein the output terminal of the operational amplifier is electrically coupled to the control terminal, wherein the third control terminal is electrically coupled to the fourth control terminal and the control contact, wherein the third input terminal is electrically coupled to a power supply, wherein the fourth input terminal is electrically coupled to the power supply, wherein the fourth output terminal is electrically coupled to the input terminal of the control transistor, and wherein the output terminal of the control transistor is electrically coupled to the first input terminal.

6. The constant current charging device according to claim 5, wherein the current compensation unit comprises:
a fifth transistor comprising a fifth control terminal, a fifth input terminal, and a fifth output terminal;
a sixth transistor comprising a sixth control terminal, a sixth input terminal, and a sixth output terminal; and
a seventh transistor comprising a seventh control terminal, a seventh input terminal, and a seventh output terminal,
wherein the fifth control terminal is electrically coupled to the sixth control terminal, the sixth output terminal, and the seventh input terminal, wherein the fifth input terminal is electrically coupled to the power supply, wherein the fifth output terminal is electrically coupled to the control contact, wherein the sixth input terminal is electrically coupled to the power supply, wherein the seventh control terminal is coupled to the output terminal of the control transistor, and wherein the seventh output terminal is electrically coupled to the ground terminal.

7. The constant current charging device according to claim 4, wherein M is a ratio of a channel width-to-length ratio of the first transistor and a channel width-to-length ratio of the second transistor.

8. The constant current charging device according to claim 5, wherein N is a ratio of a channel width-to-length ratio of the third transistor and a channel width-to-length ratio of the fourth transistor.

9. The constant current charging device according to claim 1, wherein the current compensation unit adjusts a voltage input to the control contact.

10. The constant current charging device of claim 9, wherein the charging current is zero when an input voltage of the non-inverting input terminal is equal to a reference voltage.
